(19) United States
(12) Patent Application Publication
(10) Pub. No.: US 2009/0179609 A1
(43) Pub. Date: Jul. 16, 2009

(54) HV Battery Equalization Charge During Driving Operation in Fuel Cell Hybrid Vehicles

(75) Inventors: Martin Fasse, Wiesbaden (DE); Andreas Koenekamp, Darmstadt (DE); Jochen Schaffnit, Darmstadt (DE)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/013,153

(22) Filed: Jan. 11, 2008

(51) Int. Cl. H01M 10/44

(52) U.S. Cl. 320/101

(57) ABSTRACT

A fuel cell system that includes a method for providing a battery state of charge and voltage equalization during normal operation of the fuel cell system. If a charge equalization has been requested, the method first determines whether the battery temperature is above a predetermined temperature and, if not, proceeds with battery charging and overcharging so that all of the cells in the battery are fully charged. During the charging process, the method determines whether the charging process should be interrupted, such as by a power request that exceeds a predetermined power request, which would require battery power. The method counts the number of times the state of charge and voltage equalization process has been interrupted, and if the number of times exceeds a predetermined value, then the method initiates a service condition.

### BACKGROUND OF THE INVENTION

1. Field of the Invention

This invention relates generally to a system and method for charging all of the cells in a high voltage battery to a certain state of charge (SOC) or within a certain state of charge range and, more particularly, to a system and method for charging a high voltage battery in a fuel cell system on a vehicle during vehicle operation that includes overcharging the battery so all of the cells in the battery are completely charged.

2. Discussion of the Related Art

Hydrogen is a very attractive fuel because it is clean and can be used to efficiently produce electricity in a fuel cell. A hydrogen fuel cell is an electro-chemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode.

Proton exchange membrane fuel cells (PEMFC) are a popular fuel cell for vehicles. The PEMFC generally includes a solid polymer electrolyte proton conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation.

Several fuel cells are typically combined in a fuel cell stack to generate the desired power. The fuel cell stack receives a cathode input gas, typically a flow of air forced through the stack by a compressor. Not all of the oxygen is consumed by the stack and some of the air is output as a cathode exhaust gas that may include water as a stack by-product. The fuel cell stack also receives an anode hydrogen input gas that flows into the anode side of the stack.

The dynamic power of a fuel cell system is limited. Further, the time delay from system start-up to driveability and low acceleration of the vehicle may not be acceptable. During a drive cycle, the stack cell voltage varies because the variable driver power request follows a certain stack polarization curve. The voltage cycles can decrease the stack durability. These drawbacks can be minimized by using a high voltage battery in parallel with the fuel cell stack. Algorithms are employed to provide the distribution of power from the battery and the fuel cell stack to meet the requested power.

For the reasons discussed above, some fuel cell vehicles are hybrid vehicles that employ a rechargeable supplemental power source in addition to the fuel cell stack, such as a DC battery or a super-capacitor (also referred to as an ultra-capacitor or double layer capacitor). The power source provides supplemental power for the various vehicle auxiliary loads, for system start-up and during high power demands when the fuel cell stack is unable to provide the desired power. More particularly, the fuel cell stack provides power to a traction motor and other vehicle systems through a DC voltage bus line for vehicle operation. The battery provides the supplemental power to the voltage bus line during those times when additional power is needed beyond what the stack can provide, such as during heavy acceleration. For example, the fuel cell stack may provide 70 kW of power. However, vehicle acceleration may require 100 kW or more of power. The fuel cell stack is used to recharge the battery at those times when the fuel cell stack is able to meet the system power demand. The generator power available from the traction motor during regenerative braking is also used to recharge the battery through the DC bus line.

During operation of the fuel cell system, the desired state-of-charge (SOC) of the high voltage battery is controlled to be within a certain operating range, such as between 50% and 80% of it's charge range. The high voltage battery consists of several battery cells connected in series. Due to cell-to-cell differences in cell capacity, internal resistance and connection quality, the state of charge of an individual cell drifts during operation of the battery causing some cells to be at different charge levels than other cells. If the difference between the SOCs and voltages of the individual cells in the battery becomes too large, where the battery power may be limited, a battery management system (BMS) initiates a charge equalization or charge equilibration of the battery cells.

As mentioned above, the state of charge and voltage differences between the cells in the battery sometimes require equalization. Because charging a single cell is sometimes not possible, overcharging the entire battery pack may be necessary, where overcharging of some cells is required until the cells with the lowest state of charge are one hundred percent charged. For those batteries where charging of single cells is possible, additional devices, such as separately controllable discharge resistors per cell, are necessary.

Overcharging a high voltage battery requires a very small charging current. This is usually done with a special battery charging device. This procedure typically requires the vehicle to be taken to a service station where the overcharging is performed by trained personal. It would be desirable to provide a battery management system where battery cell voltage and SOC equalization can be performed during normal operation of a fuel cell hybrid vehicle or other electric vehicles that may employ NiMH batteries.

### SUMMARY OF THE INVENTION

In accordance with the teachings of the present invention, a fuel cell system is disclosed that includes a method for providing battery state of charge and voltage equalization during normal operation of the fuel cell system. A battery management system may request a battery state of charge and voltage equalization of the battery. If this occurs, the method first determines whether the battery temperature is above a predetermined temperature and, if not, proceeds with battery charging and overcharging by the fuel cell stack so that all of the cells in the battery are fully charged. During the charging process, the method determines whether the charging process should be interrupted because of, for example, a power request that exceeds a predetermined power request, which would require battery power. The method counts the number of times the state of charge and voltage equalization has been started, but has been interrupted, and if the number of times exceeds a predetermined value, then the method initiates a service soon condition.

Additional features of the present invention will become apparent from the following description and appended claims, taken in conjunction with the accompanying drawings.

### BRIEF DESCRIPTION OF THE DRAWINGS

FIG. 1 is a schematic block diagram of a hybrid fuel cell system including a fuel cell stack and a high voltage battery; and

FIG. 2 is a flow chart diagram showing a process for providing battery cell voltage and SOC equalization during operation of the fuel cell system, according to an embodiment of the present invention.

### DETAILED DESCRIPTION OF THE EMBODIMENTS

The following discussion of the embodiments of the invention directed to a method for providing battery cell state of charge and voltage equalization during normal operation of a fuel cell system is merely exemplary in nature, and is in no way intended to limit the invention or it's applications or uses.

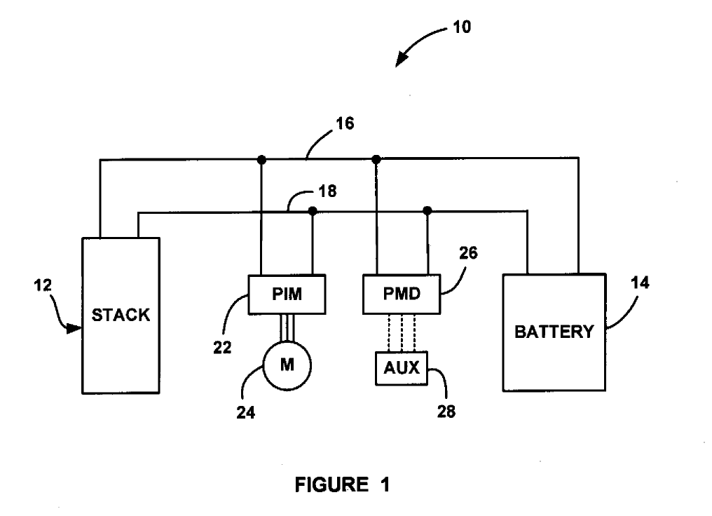

FIG. 1 is a schematic block diagram of a fuel cell system 10 including a fuel cell stack 12 and a battery 14 that includes power electronics. In order to provide battery charge or discharge, a voltage difference is needed between the stack voltage and the battery voltage that is greater than or equal to the battery voltage. When the stack voltage is greater than the battery voltage, the power electronics operates as a voltage amplifier where the gain is less than or equal to one. The fuel cell stack 12 provides electrical power to a high voltage bus line, represented here as positive bus line 16 and negative bus line 18. In a vehicle fuel cell system, the fuel cell stack 12 may include about 400 fuel cells. The battery 14 is also coupled to the high voltage bus lines 16 and 18, and provides supplemental power as discussed above.

The fuel cell system 10 includes a power inverter module (PIM) 22 electrically coupled to the bus lines 16 and 18 and an AC or DC traction motor 24. The PIM 22 converts the DC voltage on the bus lines to an AC voltage suitable for the AC traction motor 24. The traction motor 24 provides the traction power to operate the vehicle, as is well understood in the art. The traction motor 24 can be any suitable motor for the purposes described herein, such as an AC induction motor, an AC permanent magnet motor and an AC three-phase synchronous machine. During regenerative braking when the traction motor 24 is operating as a generator, electrical AC power from the motor 24 is converted to DC power by the PIM 22, which is then applied to the bus lines 16 and 18 to recharge the battery 14. A blocking diode (not shown) prevents the regenerative electrical energy applied to the bus lines 16 and 18 from flowing into the fuel cell stack 12, which could otherwise damage the stack 12.

It is known to maintain the output power of the stack 12 within a desirable voltage range for as long as possible in order to increase fuel cell stack durability in a hybrid fuel cell system. For example, it is desirable to maintain a cell voltage for each fuel cell in the stack 12 in the range of 0.725-0.85 volts. As the load on the fuel cell stack 12 goes up, the cell voltage goes down, and vice versa. It is desirable to prevent each cell voltage from going above 0.85 volts, which would be a very low stack load. Further, if the cell voltage falls below 0.725 volts for high loads, it is desirable to maintain the cell voltages in the high load range as long as possible for stack durability purposes. Also, it is desirable that the battery state of charge (SOC) does not go above its maximum charge limit or below its minimum charge limit.

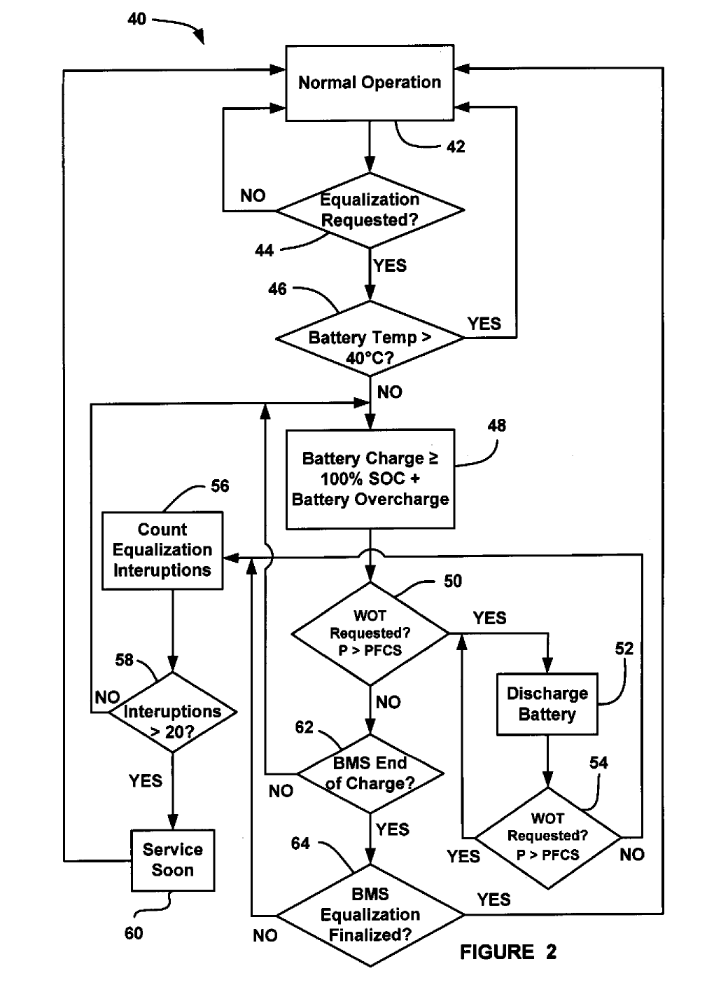

FIG. 2 is a flow chart diagram 40 showing a process where a battery management system (BMS) provides state of charge and voltage equalization during normal operation of the fuel cell system 10 if the state of charge and the voltage difference between individual battery cells in the battery 14 become too large, according to an embodiment of the present invention. The fuel cell system 10 is operating normally at box 42. The algorithm determines whether battery charge equalization is requested at decision diamond 44 by the battery management system and, if not, returns to normal operation at the box 42. Algorithms are known in the art to determine when a charge equalization should be performed, such as by a certain period of time having elapsed. If a state of charge equalization is requested at the decision diamond 44, then the algorithm determines whether the temperature of the battery 14 is above a predetermined temperature, such as 40° C., at decision diamond 46. If the battery temperature is too warm, meaning that an overcharge of the battery 14 may be too dangerous, where the battery 14 may fail or explode, the algorithm returns to the box 42 for normal system operation without performing the charge equalization. The reason that the battery charging is not initiated if the temperature of the battery 14 is too high is because of the expectation that the battery charging will not be completed as a result of the battery 14 becoming too hot. Thus, energy is not wasted by starting the charging procedure and then later having to stop the procedure.

If the battery temperature is below the predetermined temperature at the decision diamond 46, the algorithm performs the state of charge and voltage equalization by charging the battery 14 using the fuel cell stack 12 to 100% of its state of charge, and then overcharging the battery 14, at box 48, according to a predetermined battery management system current limiting procedure, so that all of the battery cells have 100% charge and are equalized. In other words, the battery 14 is overcharged according to a current limiting algorithm so that some of the cells will be fully charged and some of the cells will overcharged without damaging the battery 14. In one example, the BMS determines an amount of charge, for example, 30%, that is for a cell capacity of 7 amp hours at a charge of 2.1 amp hours, to be overcharged into the battery 14.

While the battery 14 is being charged at the box 48, several things may cause the battery charging to be interrupted. One of those things is when the vehicle operator requests a heavy acceleration that provides a power request greater than a predetermined power that requires battery power, at decision diamond 50, referred to as wide open throttle (WOT). If the vehicle operator does request a heavy acceleration at the decision diamond 50, then battery power will be used and the battery 14 will be discharged at box 52. The algorithm will then determine if the wide open throttle condition is still being requested at decision diamond 54 and, if so, return to the box 52 to use battery power to provide the increased power request.

If the heavy acceleration is not still being requested at the decision diamond 54, the algorithm will determine the number of times the equalization charging was requested and then interrupted at box 56. The algorithm will then determine if the number of times exceeds a predetermined value, such as 20, at decision diamond 58. If the number of interruptions has not exceeded the predetermined value at the decision diamond 58, then the algorithm returns to the box 48 to continue charging the battery 14 to provide 100% charge for all of the battery cells. If the number of interruptions during charge equalization has exceeded the predetermined value at the decision diamond 58, then the algorithm provides an indication to the vehicle driver that service is required, such as turning on a service soon light at box 60. The algorithm then returns to normal operation at the box 42. Particularly, if the battery 14 has discharged too much and too often where the difference between the state of charge of the cells is too large, then it may be necessary that a service station provide the battery overcharging to charge all of the battery cells as was done in the past.

If a heavy acceleration is not requested at the decision diamond 50, then the algorithm determines whether the battery management system has reached an end of charge and over-charge condition at decision diamond 62, where the battery 14 is fully charged and, if not, returns to the box 48 to continue the battery charging. If the end of charge has occurred at the decision diamond 62, then the algorithm determines whether the battery management system has finalized the equalization at decision diamond 64 and, if so, returns to the box 42 for normal fuel cell system operation. If the equalization has not been finalized at the decision diamond 64, then the algorithm continues to count the number of times that the equalization has been interrupted at the box 56. Other examples of interrupting the equalization charging includes that the battery 14 becomes too warm during the charge equalization or the vehicle is shut down. When the interrupt condition is over, the BMS will resume with overcharging until the entire amount of counting charge is reached.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing battery state of charge and voltage equalization of battery cells in a battery that is part of a fuel cell system during operation of the fuel cell system, said method comprising:
determining whether a state of charge and voltage equalization has been requested;
determining whether the temperature of the battery is greater than a predetermined temperature if the equalization has been requested;
charging the battery if the battery temperature is below the predetermined temperature, where charging the battery includes overcharging the battery so that each cell in the battery receives about a 100% state of charge; and
interrupting the equalization charging of the battery if a power request is made to the fuel cell system that exceeds a predetermined power request that would require using battery power and battery discharge.

2. The method according to claim 1 further comprising periodically determining whether the power request is still exceeding the predetermined power request as the battery is being discharged to meet the power demand.

3. The method according to claim 2 further comprising determining the number of times that an equalization request has occurred and then been interrupted by a power request that exceeds the predetermined power request.

4. The method according to claim 3 further comprising initiating a service condition if the number of interruptions exceeds a predetermined number.

5. The method according to claim 1 further comprising determining whether the state of charge and voltage equalization has been interrupted before each of the battery cells has reached about 100% state of charge.

6. The method according to claim 5 further comprising determining the number of times that the equalization charging of the battery has been interrupted.

7. The method according to claim 6 further comprising initiating a service condition if the number of interruptions exceeds a predetermined number.

8. The method according to claim 7 wherein the predetermined number is about 20.

9. The method according to claim 1 wherein determining if the battery has exceeded a predetermined battery temperature includes determining whether the battery has exceeded about 40° C.

10. A method for providing battery state of charge and voltage equalization of battery cells in a battery that is part of a fuel cell system during operation of the fuel cell system, said method comprising;
determining whether a state of charge and voltage equalization has been requested;
charging the battery if the state of charge and voltage equalization has been requested, where charging the battery includes overcharging the battery so that each cell in the battery has about 100% state of charge;
interrupting the battery equalization charging if certain conditions are met; and
counting the number of times that the battery equalization charging has been interrupted.

11. The method according to claim 10 wherein interrupting the battery equalization charging includes interrupting the battery equalization charging if a power request is made to the fuel cell system that exceeds a predetermined power request where battery power would be required to meet the power request.

12. The method according to claim 10 further comprising initiating a service condition if the number of interruptions exceeds a predetermined number.

13. The method according to claim 12 wherein the predetermined number is about 20.

14. The method according to claim 10 further comprising determining whether the temperature of the battery is greater than a predetermined temperature if the equalization has been requested, and not performing the state of charge and voltage equalization if the battery temperature is greater than the predetermined temperature.

15. The method according to claim 14 wherein the predetermined battery temperature is about 40° C.

16. A method for providing battery state of charge and voltage equalization of battery cells in a battery that is part of a fuel cell system during operation of the fuel cell system, said method comprising:
determining whether a state of charge and voltage equalization has been requested;
determining whether the temperature of the battery is greater than a predetermined temperature if the equalization has been requested;
charging the battery if the battery temperature is below the predetermined temperature, where charging the battery includes overcharging the battery so that each cell in the battery receives about 100% state of charge;
interrupting the battery equalization charging if a power request is made to the fuel cell system that exceeds a predetermined power request that would require using battery power;
interrupting the battery equalization charging if certain other conditions are met; and
counting the number of times that the battery equalization charging has been interrupted.

17. The method according to claim 16 further comprising periodically determining whether the power request is still exceeding the predetermined power request as the battery is being discharged to meet the power demand.

18. The method according to claim 16 further comprising initiating a service condition if the number of interruptions exceeds a predetermined number.

19. The method according to claim 18 wherein the predetermined number is about 20.

20. The method according to claim 16 wherein the predetermined battery temperature is about 40° C.
